(19) United States
(12) Patent Application Publication
(10) Pub. No.: US 2024/0344202 A1
(43) Pub. Date: Oct. 17, 2024

(54) WIRE AND METHOD FOR MANUFACTURING WIRE

(71) Applicant: SUMITOMO ELECTRIC INDUSTRIES, LTD., Osaka (JP)

(72) Inventors: Tomoharu TAKEYAMA, Osaka (JP); Yusuke KUREISHI, Osaka (JP); Akihisa HOSOE, Osaka (JP)

(73) Assignee: SUMITOMO ELECTRIC INDUSTRIES, LTD., Osaka (JP)

(21) Appl. No.: 18/292,631

(22) PCT Filed: Aug. 18, 2022
(86) PCT No.: PCT/JP2022/031244

§ 371 Date: Jan. 26, 2024

(30) Foreign Application Priority Data
Sep. 24, 2021 (JP) 2021-155886

(51) Int. Cl. C23C 18/32; B21C 1/02; C23C 18/16; C23C 18/18

(52) U.S. Cl. CPC C23C 18/32; B21C 1/02; C23C 18/1637; C23C 18/1692; C23C 18/1837

(57) ABSTRACT

Provided is a wire having a core wire and a coating layer positioned on the outer periphery of the core wire, wherein the core wire consists essentially of aluminum or an aluminum alloy; the coating layer consists essentially of nickel or a nickel alloy; on the core wire, an area ratio of portions not being coated with the coating layer is lower than 0.01%; the wire further has a first element; and the first element is at least one selected from the group consisting of iron, magnesium, silicon, copper, zinc, nickel, manganese, silver, chromium and zirconium.

### TECHNICAL FIELD

The present disclosure relates to a wire and a method for manufacturing a wire. The present application claims priority based on Japanese Patent Application No. 2021-155886, filed on Sep. 24, 2021, the entire contents of which are hereby incorporated by reference.

### BACKGROUND ART

WO2020/217937 (Patent Literature 1) discloses an aluminum base wire comprising a core wire composed of pure aluminum or an aluminum alloy, coating pieces provided on the outer periphery of the core wire and a coating layer provided to the outer periphery of the core wire and the outer periphery of the coating pieces. The coating pieces are composed of copper or a copper alloy. The coating layer has a first layer and a second layer. The first layer is composed of a metal containing copper and tin, and the second layer is composed of tin or a tin alloy.

Then, Japanese Patent No. 6821148 (Patent Literature 2) discloses a metal material comprising a base material, an oxide layer provided on the surface of the base material and a meal layer provided on the surface of the oxide layer. The base material includes aluminum. The oxide layer includes aluminum, nickel and oxygen. The metal layer includes nickel. The average thickness of the oxide layer is 50 nm or more and 250 nm or less.

Further, WO2018/124116 (Patent Literature 3) discloses a surface-treated material comprising an electroconductive substrate, a surface treatment coating film formed on the electroconductive substrate, and an interdiffusion layer provided between the electroconductive substrate and the surface treatment coating film. The electroconductive substrate is made of aluminum or an aluminum alloy. The surface treatment coating film is made of nickel or the like. The interdiffusion layer includes a metal component in the electroconductive substrate, a metal component in the surface treatment coating film, and an oxygen component. The average thickness of the interdiffusion layer is 1 nm or more and 40 nm or less.

### CITATION LIST

### Patent Literature

PTL 1: WO2020/217937
PTL 2: WO2020/171359
PTL 3: WO2018/124116

### SUMMARY OF INVENTION

A wire according to the present disclosure is a wire comprising:
a core wire; and
a coating layer positioned on the outer periphery of the core wire,
wherein the core wire consists essentially of aluminum or an aluminum alloy;
the coating layer consists essentially of nickel or a nickel alloy;
on the core wire, the area ratio of portions not being coated with the coating layer is lower than 0.01%;
the wire further comprises a first element; and
the first element is at least one selected from the group consisting of iron, magnesium, silicon, copper, zinc, nickel, manganese, silver, chromium and zirconium.

A method for manufacturing a wire according to the present disclosure is a method for manufacturing a wire comprising a core wire and a coating layer positioned on the outer periphery of the core wire, the method comprising:
preparing the core wire consisting essentially of aluminum or an aluminum alloy;
carrying out degreasing to remove oil content adhered on the surface of the core wire;
carrying out an etching treatment to remove an oxide film present on the surface of the core wire and containing aluminum oxide as a main component;
carrying out electroless plating to form a nickel coating on the surface of the core wire having been subjected to the etching treatment;
forming the coating layer consisting essentially of nickel or a nickel alloy on the surface of the core wire having the nickel coating formed thereon; and
subjecting the core wire having the coating layer formed thereon to wire drawing,
wherein the wire further comprises a first element;
the first element is at least one selected from the group consisting of iron, magnesium, silicon, copper, zinc, nickel, manganese, silver, chromium and zirconium; and
the solubility of aluminum oxide to an etching solution to be used for the etching treatment is higher than the solubility of aluminum to the etching solution.

### BRIEF DESCRIPTION OF DRAWINGS

FIG. 1 is a cross-sectional view showing an outline of a wire of an embodiment 1 of the present disclosure.

FIG. 2 is a cross-sectional view showing another example of the wire of embodiment 1 of the present disclosure.

FIG. 3 is a cross-sectional view showing another example of the wire of embodiment 1 of the present disclosure.

FIG. 4 is a cross-sectional view showing an outline of a wire of an embodiment 2 of the present disclosure.

FIG. 5 is a cross-sectional view showing another example of the wire of embodiment 2 of the present disclosure.

FIG. 6 is a cross-sectional view showing another example of the wire of embodiment 2 of the present disclosure.

FIG. 7 is an explanatory diagram to explain part of steps in a conventional method for manufacturing a wire.

FIG. 8 is an explanatory diagram to explain part of steps in a method for manufacturing a wire of the present disclosure.

FIG. 9 is an example of SEM images of surfaces of a coating layer of Sample 1.

FIG. 10 is an example of SEM images of surfaces of a coating layer of Sample A.

### DETAILED DESCRIPTION

### Problem to be Solved by the Present Disclosure

In recent years, as materials to be plated to be used for forming electric contacts and the like, use of aluminum or an aluminum alloy has been increased. Then, the aluminum or aluminum alloy contains, as segregated matter, impurities such as iron or magnesium.

On the surface of the aluminum or aluminum alloy, however, an oxide film called passive state film is easily formed and the presence of the oxide film makes carrying out plating difficult. Hence, as a pretreatment for plating, an etching treatment to remove the oxide film is carried out. The etching treatment usually uses a strong alkaline aqueous solution such as a sodium hydroxide aqueous solution, but when a strong alkaline aqueous solution is used, not only the oxide film but also even part of a core wire of aluminum, an aluminum alloy or the like is removed. At this time, when the segregated matter as described above is present, the segregated matter is also removed, resulting in making voids of a few hundreds of micrometers in width and a few tens of micrometers in depth. Even when plating is carried out on these void portions, such a disadvantage arises that complete plating cannot be made and the core wire is exposed.

Then, the present disclosure has an object to provide a wire suppressed in exposure of its core wire.

### Advantageous Effect of the Present Disclosure

According to the present disclosure, a wire suppressed in exposure of its core wire becomes enabled to be provided.

### DESCRIPTION OF EMBODIMENTS

First, embodiments of the present disclosure will be listed and described.
(1) A wire according to one aspect of the present disclosure is a wire comprising:
   a core wire; and
   a coating layer positioned on the outer periphery of the core wire,
   wherein the core wire consists essentially of aluminum or an aluminum alloy;
   the coating layer consists essentially of nickel or a nickel alloy;
   on the core wire, the area ratio of portions not being coated with the coating layer is lower than 0.01%;
   the wire further comprises a first element; and
   the first element is at least one selected from the group consisting of iron, magnesium, silicon, copper, zinc, nickel, manganese, silver, chromium and zirconium.

An etching treatment is carried out as a pretreatment when a plating treatment is carried out on a core wire, but since a conventional method brings about excessive etching of the core wire itself, the plating treatment is not carried out uniformly and such a phenomenon arises that the core wire is exposed. The wire according to one aspect of the present disclosure can be provided as a wire suppressed in exposure of its core wire by improving the conventional etching treatment.
(2) In the wire of the above (1),
   the wire further comprises an anchor particle comprising the first element and an oxide of the first element, and
   the anchor particle may be present straddling the interface between the core wire and the coating layer.

With the wire comprising the anchor particle present straddling the interface between the core wire and the coating layer, the adhesiveness between the core wire and the coating layer is improved by the anchor effect, and peeling of the coating layer is suppressed even when bending acts on the wire.
(3) In the wire of the above (2), the particle diameter of the anchor particle may be 0.1 μm or more and 50 μm or less.

By the above specification, the adhesiveness between the core wire and the coating layer is more improved.
(4) In the wire of any one of the above (1) to (3), an interdiffusion layer is further provided between the core wire and the coating layer,
   wherein the interdiffusion layer may contain aluminum, nickel and oxygen.

By the above specification, the adhesiveness between the core wire and the coating layer is more improved.
(5) In the wire of the above (4), the interdiffusion layer comprises a base layer positioned on the core wire side and a composite layer positioned on the coating layer side,
   the base layer may have a higher content of aluminum than that of nickel; and
   the composite layer may have a higher content of nickel than that of aluminum.

By the above specification, the adhesiveness between the core wire and the coating layer is more improved.
(6) In the wire of the above (4) or (5), the average thickness of the interdiffusion layer may be 10 nm or more and 250 nm or less.

By the above specification, the adhesiveness between the core wire and the coating layer is more improved.
(7) In the wire of any one of the above (4) to (6), the average thickness of the interdiffusion layer may be 50 nm or more and 250 nm or less.

By the above specification, the adhesiveness between the core wire and the coating layer is more improved.
(8) In the wire of any one of the above (1) to (7), the average thickness of the coating layer may be 3 μm or more and 15 μm or less.

By the above specification, the adhesiveness between the core wire and the coating layer is more improved.
(9) In the wire of any one of the above (1) to (8), the diameter of the wire may be 0.04 mm or more and 4 mm or less.

Since such a wire, though being an easily bending thin wire, is suppressed in peeling of the coating layer, such a wire is readily utilized in various applications.
(10) A method for manufacturing a wire according to one aspect of the present disclosure is a method for manufacturing a wire comprising a core wire and a coating layer positioned on the outer periphery of the core wire, the method comprising:
   preparing the core wire consisting essentially of aluminum or an aluminum alloy;
   carrying out degreasing to remove oil content adhered on the surface of the core wire;
   carrying out an etching treatment to remove an oxide film present on the surface of the core wire and containing aluminum oxide as a main component;
   carrying out electroless plating to form a nickel coating on the surface of the core wire having been subjected to the etching treatment;
   forming the coating layer consisting essentially of nickel or a nickel alloy on the surface of the core wire having the nickel coating formed thereon; and
   subjecting the core wire having the coating layer formed thereon to wire drawing,
   wherein the wire further comprises a first element; and
   the first element is at least one selected from the group consisting of iron, magnesium, silicon, copper, zinc, nickel, manganese, silver, chromium and zirconium; and
   the solubility of aluminum oxide to an etching solution to be used for the etching treatment is higher than the solubility of aluminum to the etching solution.

The wire manufactured by the above manufacturing method becomes a wire suppressed in exposure of the core wire.
(11) In the wire in the above (10), the wire further comprises an anchor particle comprising the first element and an oxide of the first element, and
   the anchor particle may be present straddling the interface between the core wire and the coating layer.

The wire manufactured by the thus specified manufacturing method is improved in the adhesiveness between the core wire and the coating layer.
(12) In the method for manufacturing a wire of the above (10) or (11), the etching time in the etching treatment may be 1 min or longer and 5 min or shorter.

The wire manufactured by the thus specified manufacturing method is more suppressed in exposure of the core wire.
(13) In the method for manufacturing a wire of any one of the above (10) to (12), the etching solution may contain sulfamic acid or a sulfamate salt.

The wire manufactured by the thus specified manufacturing method is more suppressed in exposure of the core wire.
(14) In the method for manufacturing a wire of any one of the above (10) to (13), the method may further comprise subjecting the core wire having the coating layer formed thereon to a heat treatment at a temperature of 300° C. or more and 600° C. or less to form an interdiffusion layer containing aluminum, nickel and oxygen between the core wire and the coating layer.

By the above specification, the adhesiveness between the core wire and the coating layer is more improved.

### DETAILED DESCRIPTION OF EMBODIMENTS

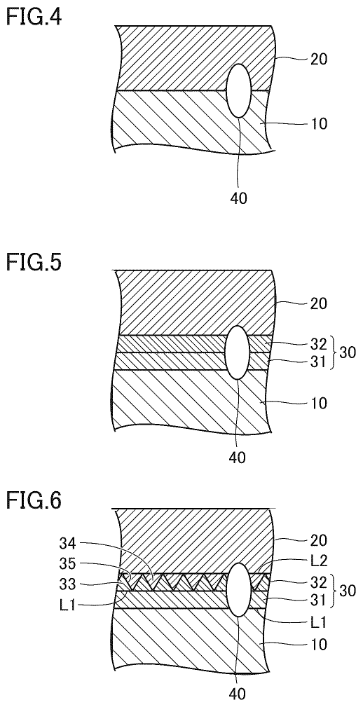

Details of embodiments of the present disclosure will be described hereinafter. In the drawings of the present disclosure, the same reference signs represent the same portions or corresponding portions. Then, the dimensional relation among length, width, thickness, depth and the like is suitably varied for clarification and simplification of the drawings, and does not always represent an actual dimensional relation. Further, FIGS. 1 to 6 are shown in cross-sections cut along a plane parallel to the longitudinal direction of the wires; and in the cross-section of a wire, although only a half in the diameter direction of the wire is shown, the other half also has the same structure.

### Embodiment 1

A wire of the present embodiment will be described with reference to FIG. 1. The wire of the present embodiment has a core wire 10, and a coating layer 20 positioned on the outer periphery of the core wire 10. Core wire 10 consists essentially of aluminum or an aluminum alloy. Coating layer 20 consists essentially of nickel or a nickel alloy. On the core wire, the area ratio of portions not being coated with the coating layer is lower than 0.01%. The wire further has a first element. The first element is at least one selected from the group consisting of iron, magnesium, silicon, copper, zinc, nickel, manganese, silver, chromium and zirconium.

### <Core Wire>

Core wire 10 consists essentially of aluminum or an aluminum alloy. In the present embodiment, “consisting essentially of aluminum or an aluminum alloy” means that core wire 10 contains 90% by mass or more, preferably 95% by mass or more, more preferably 99% by mass of aluminum or an aluminum alloy. Then, the “aluminum (Al)” herein is a pure aluminum containing 99% by mass or more of aluminum. As the pure aluminum, usable is, for example, a 1000-series aluminum prescribed in JIS H 4000 (2014). As the 1000-series aluminum, A1070 can be used. Further, the “aluminum (Al) alloy” herein is an aluminum base alloy containing 50% by mass or more, preferably 90% by mass or more of aluminum and containing one or more kinds of first element other than aluminum. Examples of the first element include iron (Fe), magnesium (Mg), silicon (Si), copper (Cu), zinc (Zn), nickel (Ni), manganese (Mn), silver (Ag), chromium (Cr) and zirconium (Zr). The total content of the first element includes being 1% by mass or more and lower than 50% by mass, and further, being 1% by mass or more and lower than 10% by mass. In the case of containing iron as the first element, the content of iron includes being 0.2% by mass or more and 3.0% by mass or less; and in the case of containing magnesium as the first element, the content of magnesium includes being 0.4% by mass or more and 5% by mass or less. As such aluminum alloys, various kinds of alloys prescribed in JIS H 4000 (2014), for example, 5000-series aluminum alloys, can be used. As the 5000-series aluminum alloys, A5052 can be used.

The shape of core wire 10 can suitably be selected according to applications and the like of the wire. Examples of the cross-sectional shape of core wire 10 include a circular shape and a nearly circular shape.

The diameter of core wire 10 is, depending on applications and the like of the wire, for example, 0.04 mm or more and 4 mm or less. Here, the diameter of core wire 10 means a diameter of core wire 10 being a single wire, and in the case of a nearly circular shape, means a length of the major axis. Then, the “major axis length” indicates a length of a line segment longest among line segments connecting two points on the outer periphery of core wire 10. In the case where the diameter of core wire 10 is 0.04 mm or more, the strength of the wire is easily held and the wire excellent in flex resistance is easily obtained. In the case where the diameter of core wire 10 is 4 mm or less, bending processability of the wire is easily improved. The diameter of core wire 10 is preferably 0.1 mm or more and 3 mm or less and more preferably 0.5 mm or more and 2 mm or less.

The diameter of core wire 10 can be determined from a scanning electron microscope (SEM) image obtained by observation by a SEM. The magnification of the SEM image can be made to be, for example, 50 times. In the SEM image, diameters of core wire 10 are measured at 10 different positions and the average value thereof is taken as the diameter of core wire 10.

### <Coating Layer>

Coating layer 20 is positioned on the outer periphery of core wire 10 and chemically protects core wire 10. Coating layer 20 consists essentially of nickel or a nickel alloy. In the present embodiment, “consisting essentially of nickel or a nickel alloy” means that coating layer 20 contains 90% by mass or more, preferably 95% by mass or more, more preferably 99% by mass of nickel or a nickel alloy.

The average thickness of coating layer 20 is, for example, 3 μm or more and 15 μm or less. In the case where the average thickness of coating layer 20 is 3 μm or more, the adhesiveness between core wire 10 and coating layer 20 is easily improved. In the case where the average thickness of coating layer 20 is 15 μm or less, bending processability of the wire is easily improved. The average thickness of coating layer 20 is preferably 4 μm or more and 12 μm or less and more preferably 6 μm or more and 10 μm or less.

The average thickness of coating layer 20 can be determined from a SEM image obtained by observation by SEM of a cross-section of the wire. The magnification of the SEM image can be made to be, for example, 50,000 times. In the SEM image, the thicknesses of coating layer 20 are measured at 10 different positions and the average value thereof is taken as the average thickness of coating layer 20. The thickness of coating layer 20 is a length from the interface between core wire 10 and coating layer 20 to the surface of coating layer 20.

### (Area Ratio)

In a step of forming coating layer 20 in a manufacturing method described later, portions where no coating layer 20 is formed may be formed on core wire 10 in some cases. That is, portions not being coated with coating layer 20 are generated on core wire 10. The area ratio of the portions not being coated with coating layer 20 on core wire 10 is lower than 0.01% and preferably 0%.

The area ratio of the portions not being coated with coating layer 20 is determined by mirror finishing any surface of coating layer 20, observing the mirror finished surface by SEM and image analyzing a photographed image thereof. Specifically, an area of portions not being coated with coating layer 20 is calculated from the photographed image; and the area ratio of the portions not being coated with coating layer 20 is a value obtained by dividing an area of the visual field of the photographed image by the area of the portions not being coated with coating layer 20 in the photographed image. Then, it is preferable that in the same wire, the image analysis is carried out on a plurality of visual fields and the average value thereof is taken as the area ratio of portions not being coated with coating layer 20. The number of visual fields on which the image analysis is carried out is preferably 5 or more visual fields, more preferably 7 or more visual fields and still more preferably 10 or more visual fields. One visual field may be, for example, 100 μm long×100 μm wide.

### <Interdiffusion Layer>

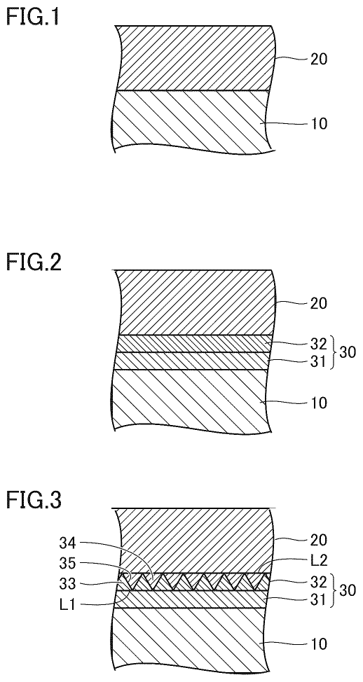

With reference to FIG. 2, the wire in the present embodiment may further have an interdiffusion layer 30. Interdiffusion layer 30 is provided between the core wire 10 and coating layer 20. Interdiffusion layer 30 contains aluminum, nickel and oxygen. Interdiffusion layer 30 may have a base layer 31 and a composite layer 32. Here, in the case where the wire has the interdiffusion layer, the “area ratio of portions not being coated with coating layer 20” on above-mentioned core wire 10 is rephrased as the “area ratio of portions not being coated with coating layer 20 and interdiffusion layer 30”.

The content of oxygen contained in interdiffusion layer 30 is, for example, 20 atomic % or more and 55 atomic % or less. In the case where the content of oxygen contained in interdiffusion layer 30 satisfies the above range, the adhesiveness between core wire 10 and coating layer 20 is easily improved. The content of oxygen contained in interdiffusion layer 30 is preferably 22 atomic % or more and 45 atomic % or less and more preferably 25 atomic % or more and 35 atomic % or less.

The average thickness of interdiffusion layer 30 is, for example, 10 nm or more and 250 nm or less. In the case where the average thickness of interdiffusion layer 30 is 10 nm or more, the adhesiveness between core wire 10 and coating layer 20 is easily improved. In the case where the average thickness of interdiffusion layer 30 is 250 nm or less, bending processability of the wire is easily improved. The average thickness of interdiffusion layer 30 is preferably 50 nm or more and 250 nm or less and more preferably 50 nm or more and 150 nm or less.

The average thickness of interdiffusion layer 30 can be determined from a SEM image obtained by observation by SEM of a cross-section of core wire 10. The magnification of the SEM image can be made to be, for example, 50,000 times. In the SEM image, the thicknesses of interdiffusion layer 30 are measured at 10 different positions and the average value thereof is taken as the average thickness of interdiffusion layer 30. The thickness of interdiffusion layer 30 is a length from the interface between core wire 10 and interdiffusion layer 30 to the interface between interdiffusion layer 30 and coating layer 20.

### (Base Layer)

Base layer 31 is positioned on the core wire 10 side, that is, between core wire 10 and composite layer 32. Base layer 31 has a higher content of aluminum than that of nickel. With base layer 31 containing much of aluminum, the adhesiveness between core wire 10 and interdiffusion layer 30 is easily improved. The content of aluminum contained in base layer 31 is, for example, 30 atomic % or more and 60 atomic % or less. In the case where the content of aluminum contained in base layer 31 satisfies the above range, the adhesiveness between core wire 10 and interdiffusion layer 30 is easily improved. The content of aluminum contained in base layer 31 is preferably 35 atomic % or more and 55 atomic % or less and more preferably 40 atomic % or more and 50 atomic % or less. In the case where core wire 10 consists of an aluminum alloy, it is preferable that base layer 31 contains the first element contained in the aluminum alloy. Base layer 31 consists mainly of an aluminum oxide.

The average thickness of base layer 31 is, for example, 30 nm or more and 230 nm or less. In the case where the average thickness of base layer 31 is 30 nm or more, the adhesiveness between core wire 10 and interdiffusion layer 30 is easily improved. In the case where the average thickness of base layer 31 is 230 nm or less, some relative thickness of composite layer 32 can be secured. The average thickness of base layer 31 is preferably 40 nm or more and 150 nm or less and more preferably 50 nm or more and 100 nm or less.

The average thickness of base layer 31 can be determined from a SEM image obtained by observation by SEM of a cross-section of the wire. The magnification of the SEM image can be made to be, for example, 50,000 times or more. In the SEM image, the thicknesses of base layer 31 are measured at 10 different positions and the average value thereof is taken as the average thickness of base layer 31. The thickness of base layer 31 is a length along the lamination direction of each layer from the surface of core wire 10 to the boundary between base layer 31 and composite layer 32. The boundary between base layer 31 and composite layer 32 will be described later.

### (Composite Layer)

Composite layer 32 is positioned on the coating layer 20 side, that is, between coating layer 20 and base layer 31. Composite layer 32 has a higher content of nickel than that of aluminum. In the case where composite layer 32 contains much of nickel, the adhesiveness between interdiffusion layer 30 and coating layer 20 is easily improved. The content of nickel contained in composite layer 32 is, for example, 25 atomic % or more and 70 atomic % or less. In the case where the content of nickel contained in composite layer 32 satisfies the above range, the adhesiveness between interdiffusion layer 30 and coating layer 20 is easily improved. The content of nickel contained in composite layer 32 is preferably 32 atomic % or more and 60 atomic % or less and more preferably 35 atomic % or more and 50 atomic % or less. With reference to FIG. 3, composite layer 32 may be so configured that base parts 33 and coating parts 34 are composited.

The plurality of base parts 33 projects from base layer 31. Between neighboring base parts 33, recessed parts 35 are provided. Each base part 33 consists essentially of the same composition as that of base layer 31.

The projecting height of base part 33 is a length along the lamination direction from the boundary between base layer 31 and composite layer 32 to the apex of base part 33. The boundary between base layer 31 and composite layer 32 is a line L1 made by connecting most recessed portions of neighboring recessed parts 35 by straight lines. The projecting height of base parts 33 is, for example, 20 nm or more and 220 nm or less. In recessed parts 35 provided between neighboring base parts 33, coating parts 34 are present. In the case where the projecting height of base parts 33 is 20 nm or more, large recessed parts 35 are easily secured, and large contact areas between recessed parts 35 and coating parts 34 are easily secured. Then, in the case where the projecting height of base parts 33 is 20 nm or more, the adhesiveness between base parts 33 and coating parts 34 can be made high by the anchor effect. On the other hand, with the projecting height of base parts 33 being 220 nm or less, thickening of composite layer 32 can be suppressed and some relative thickness of base layer 31 can be secured. The projecting height of base parts 33 is preferably 30 nm or more and 150 nm or less and more preferably 40 nm or more and 100 nm or less.

The projecting height of base parts 33 can be determined from a SEM image obtained by observation by SEM of a cross-section of the wire. The magnification of the SEM image can be made to be, for example, 50,000 times. In the SEM image, the projecting heights of 10 or more base parts 33 are measured and the average value thereof is taken as the projecting height of base parts 33. A projecting height is a length between the vertex and the base of base part 33 in a straight line along the lamination direction and drawn through the vertex and the base of base part 33 in the SEM image.

The interval between vertices of neighboring base parts 33 is, for example, 5 nm or more and 80 nm or less. In the case where the interval between the vertices of neighboring base parts 33 is 5 nm or more, a large contact area between coating parts 34 and coating layer 20 is easily secured, and the adhesiveness between interdiffusion layer 30 and coating layer 20 is easily improved. In the case where the interval between the vertices of neighboring base parts 33 is 80 nm or less, many of base parts 33 and recessed parts 35 are easily provided and the adhesiveness between base parts 33 and coating parts 34 by the anchor effect is easily made to be high. The interval between the vertices of neighboring base parts 33 is preferably 10 nm or more and 60 nm or less and more preferably 15 nm or more and 40 nm or less.

Coating part 34 is positioned between neighboring base parts 33. Each coating part 34 consists essentially of the same composition as that of coating layer 20. Coating parts 34 contribute to the improvement of the adhesiveness with coating layer 20. Coating part 34 is positioned typically in a region constituted of a line connecting the vertices of neighboring base parts 33 and recessed part 35.

The average thickness of composite layer 32 is, for example, 20 nm or more and 220 nm or less. In the case where composite layer 32 is configured by compositing of base parts 33 and coating parts 34, the average thickness of composite layer 32 corresponds to the projecting height of base parts 33. In the case where the average thickness of the composite layer is 20 nm or more, the adhesiveness between interdiffusion layer 30 and coating layer 20 is easily improved. In the case where the average thickness of composite layer 32 is 220 nm or less, some relative thickness of base layer 31 can be secured. The average thickness of composite layer 32 is preferably 40 nm or more and 150 nm or less and more preferably 50 nm or more and 100 nm or less.

The average thickness of composite layer 32 can be determined from a SEM image obtained by observation by SEM of a cross-section of the wire. The magnification of the SEM image can be made to be, for example, 50,000 times. In the SEM image, the thicknesses of composite layer 32 are measured at 10 different positions and the average value thereof is taken as the average thickness of composite layer 32. The thickness of composite layer 32 is taken as the projecting height of base parts 33.

Then, in the case where interdiffusion layer 30 has base layer 31 and composite layer 32, the thickness of interdiffusion layer 30 is the total of thicknesses of base layer 31 and composite layer 32. Then, in the case where interdiffusion layer 30 has base layer 31 and composite layer 32, the interface between coating layer 20 and interdiffusion layer 30 is a line L2 made by connecting the vertices of neighboring base parts 33 by straight lines.

### <Diameter of Wire>

The diameter of the wire is, for example, 0.04 mm or more and 4 mm or less. In the case where the diameter of the wire is 0.04 mm or more, the strength of the wire is easily held and the wire is excellent in flex resistance. In the case where the diameter of the wire is 4 mm or less, bending processability of the wire is easily improved. The diameter of the wire is preferably 0.1 mm or more and 3 mm or less and more preferably 0.5 mm or more and 2 mm or less.

The diameter of the wire can be determined from a SEM image obtained by observation by SEM. The magnification of the SEM image can be made to be, for example, 50 times. In the SEM image, the diameters of the wire are measured at 10 different positions and the average value thereof is taken as the diameter of the wire.

### Embodiment 2

A wire of the present embodiment will be described with reference to FIGS. 4 to 6. The wire of the present embodiment further has an anchor particle 40 containing the first element and an oxide of the first element. Anchor particle 40 is present straddling the interface between core wire 10 and coating layer 20. Then, duplicate descriptions with embodiment 1 will be omitted.

### <Anchor Particle>

Anchor particle 40 contains the first element and an oxide containing at least one kind of the first element. Anchor particle 40 is constituted of an outer layer consisting of the oxide containing at least one kind of the first element and an inner layer consisting of the first element. It is preferable that the first element is at least one selected from the group consisting of magnesium and iron.

The shape of anchor particle 40 is not especially limited, and examples thereof include globular, elliptical and rod shapes. The particle diameter of anchor particle 40 is, for example, 0.1 μm or more and 50 μm or less. In the case where the particle diameter of anchor particle 40 satisfies the above range, the adhesiveness between core wire 10 and coating layer 20 is easily improved. It is preferable that the particle diameter of anchor particle 40 is 1 μm or more and 40 μm or less.

The particle diameter of anchor particle 40 can be determined from a SEM image obtained by observation by SEM of a cross-section of the wire. The magnification of the SEM image can be made to be, for example, 20,000 times. In the SEM image, the major axis lengths of 10 different anchor particles 40 are measured and the average value thereof is taken as the particle diameter of anchor particles 40. Here, the “major axis length” indicates a length of a line segment longest among line segments connecting two points on the outer periphery of anchor particle 40 in a cross-section of the wire.

Anchor particle 40 is present straddling the interface between core wire 10 and coating layer 20. Here, the interface between core wire 10 and coating layer 20 means the boundary between core wire 10 and coating layer 20 in any cross-section of the wire. That is, at least one particle of anchor particles 40 is present, a part of the at least one particle being present in core wire 10 and the other part thereof being present in coating layer 20. With anchor particle 40 intervening between core wire 10 and coating layer 20, the adhesiveness between core wire 10 and coating layer 20 is easily improved by the anchor effect. Then, in the case where interdiffusion layer 30 is present between core wire 10 and coating layer 20, anchor particle 40 is present straddling also interdiffusion layer 30; and the adhesiveness between core wire 10 and interdiffusion layer 30 and the adhesiveness between coating layer 20 and interdiffusion layer 30 are easily improved, by the anchor effect. Then, there is a case where a maldistributed particle (not shown in figure) having the same composition as anchor particle 40 is present only in core wire 10. In this case, there is no effect as seen in anchor particle 40 and the maldistributed particle is present as a constituent of core wire 10.

The area ratio of anchor particles 40 in any cross-section of the wire in the present embodiment is preferably 2.0% or more and 4.0% or less and more preferably 1.0% or more and 6.0% or less. With the area ratio of anchor particles 40 being 2.0% or more and 4.0% or less, the adhesiveness between core wire 10 and coating layer 20 is easily improved.

The area ratio of anchor particles 40 is determined by mirror finishing any cross-section of the wire, observing the mirror finished surface by SEM and image analyzing a photographed image thereof. The analysis is enabled by using an image processing software (“Image.”) as image analyzing software, and binarization processing the SEM image. Here, the binarization processing refers to a processing in which the densities of each pixel are converted to two values of 1 and 0 through a certain reference value (threshold value).

Specifically, the binarization processing to recognize anchor particles 40 is carried out on the SEM image by using the image processing software (“ImageJ”) to obtain a binarized image. Here, the binarization processing is carried out, for example, based on the lightness of the pixels. The threshold value of the lightness in the binarization processing is 120, and a darkfield in the SEM image after the binarization processing corresponds to a region where anchor particle 40 is present. The area ratio of anchor particles 40 in a visual field (binarized image) can be calculated by calculating the sum (total area) of areas of anchor particles 40 in the SEM image based on the binarized image, and dividing the sum by the area of the entire of the visual field (binarized image). Then, the above image analysis is carried out on a plurality of visual fields in the same wire and the average value thereof can be regarded as the area ratio of anchor particles 40 in the entire of cross-sections of the wire. The number of visual fields to be image analyzed is preferably 5 or more visual fields, more preferably 7 or more visual fields and still more preferably 10 or more visual fields. One visual field may be, for example, a square of 5.0 μm long×5.0 μm wide.

### Embodiment 3

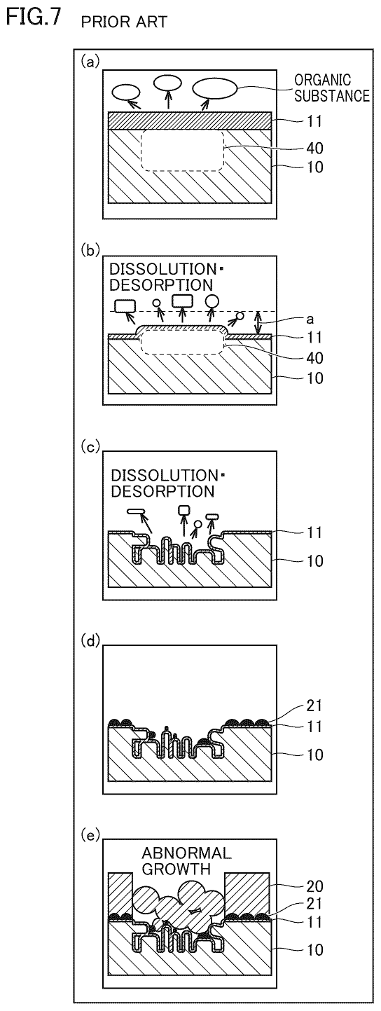

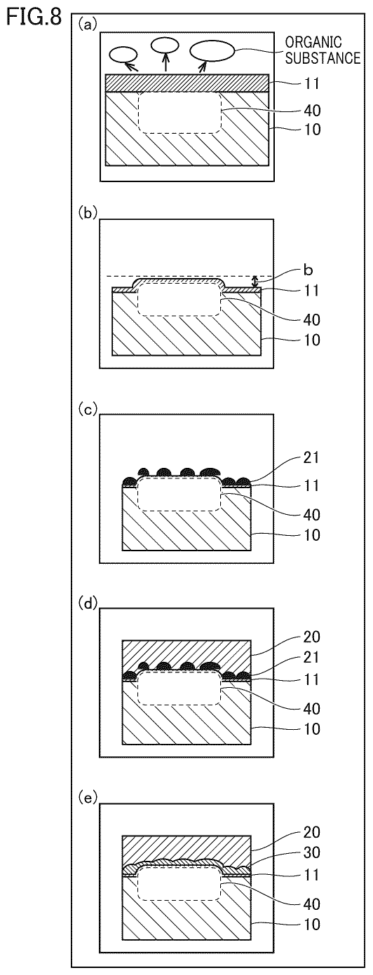

A method for manufacturing the wire of the present embodiment will be described with reference to FIGS. 7 and 8.

### [Preparation Step]

In a preparation step, core wire 10 containing the aluminum or the aluminum alloy and the first element is prepared. The aluminum, aluminum alloy and first element are as described in the above.

### <Degreasing Step>

In a degreasing step (FIG. 8(a)), oil content adhered on the surface of core wire 10 is removed. The degreasing is carried out, for example, by using an alkali degreasing agent. The present step is a step similar to a conventional degreasing step (FIG. 7(a)).

### <Etching Step>

In an etching step, an oxide film 11 present on the surface of core wire 10 is removed. Oxide film 11 is a passive film constituted mainly of aluminum oxide.

The conventional etching treatment is generally carried out by using a high alkaline aqueous solution such as a sodium hydroxide aqueous solution. When the etching treatment is carried out by using a high alkaline aqueous solution, however, such a problem is posed that not only oxide film 11 is removed, but also core wire 10 itself is excessively etched to form unevenness on the core wire 10 surface (FIG. 7(b)). Further, in the case where the etching treatment is carried out, a treatment to remove smut becomes necessary (FIG. 7(c)). The smut is impurities contained in aluminum hydroxide and aluminum alloys, and makes a cause of poor appearance and defective plating adhesion thereafter.

Then, the present inventors, in order to cope with the above problem, have found use for the etching treatment of an etching solution to which solution the solubility of aluminum oxide being a main component of oxide film 11 is higher than the solubility of aluminum being a main component of core wire 10. Thereby, oxide film 11 present on the surface of core wire 10 can selectively be removed (FIG. 8(b)). Unlike the conventional etching treatment, since excessive etching of core wire 10 is alleviated, the generation of smut is suppressed and a desmutting step becomes unnecessary. Here, the “main component” refers to a component contained in 50% by mass or more in oxide film 11.

Then, it is preferable that the etching time in the etching treatment is 1 min or longer and 5 min or shorter. With the thus-specified etching time, oxide film 11 can be removed more selectively and excessive etching of core wire 10 can be alleviated more.

Examples of such an etching solution include aqueous solutions containing sulfamic acid or a sulfamate salt. Examples of the sulfamate salt include alkali metal salts such as a sodium salt and a potassium salt, alkaline earth metal salts such as a calcium salt, a strontium salt and a barium salt, metal salts such as a manganese salt, a copper salt, a zinc salt, an iron salt, a cobalt salt and a nickel salt, and an ammonium salt and a guanidine salt. These may be used singly in one kind, or may be used in a combination of two or more kinds.

All these etching solutions meet the above-mentioned relation of the solubility. That is, it is met that the solubility of aluminum oxide to these etching solutions is higher than that of aluminum to these etching solutions.

The solubility of each component of aluminum oxide and aluminum to the etching solution is determined as follows. That is, the solubility is determined by calculating the amount of each component dissolved when 1 g of each component is immersed for 120 min in 100 g of the etching solution (concentration: 10% by mass) at 25° C.

### <Electroless Plating Step>

In an electroless plating step (FIG. 8(c)), a nickel coating 21 is formed on the surface of core wire 10 having been subjected to the etching treatment. Specifically, the electroless plating is carried out by immersing core wire 10 in a nickel plating solution. The present step is a step similar to a conventional electroless plating step (FIG. 7(d)).

The nickel plating solution has a pH at 25° C. of higher than 9 and lower than 11. By carrying out the electroless plating by using a relatively high-pH alkaline nickel plating solution, nickel coating 21 can be provided on the surface of core wire 10. The pH of the nickel plating solution is preferably 10 or more and lower than 11 and more preferably 10.5 or more and lower than 11.

The temperature of the nickel plating solution in the electroless plating treatment is, for example, 20° C. or more and 100° C. or less. The treatment time of the electroless plating is, for example, 1 min or longer and 20 min or shorter and preferably 2 min or longer and 10 min or shorter.

The nickel plating solution contains a nickel compound being a supply source of nickel ions. Examples of the nickel compound include nickel sulfate, nickel chloride and nickel nitrate. Examples of the concentration of the nickel compound include 0.1 g/L or more and 50 g/L or less.

The nickel plating solution, in addition to the nickel compound, may contain additives such as a reductant, a complexing agent, a pH buffer, a brightener and a surfactant. The reductant is a compound to reduce nickel ions. Examples of the reductant include sodium hypophosphite, boron compounds and hydrazine compounds. The complexing agent is a compound to form a complex with a metal ion in the nickel plating solution and stabilize the metal ion. The complexing agent can suitably be selected according to the kind of a metal salt. Examples of the complexing agent include ammonium salts of sulfuric acid, phosphoric acid, hydrochloric acid or the like, sulfamic acid, glycine, ethylenediamine, ethylenediaminetetraacetic acid and organic carboxylic acids. The pH buffer is a compound to prevent precipitation of metal ions. Examples of the pH buffer include boric acid, acetic acid and citric acid. The brightener is a compound to smooth the surface of a layer to be obtained. Examples of the brightener include saccharin sodium, sodium naphthalenedisulfonate, sodium sulfate and butynediol. The surfactant includes sodium dodecylsulfate and polyoxyethylene alkyl ethers. The concentrations of the additives are not especially limited.

### <Coating Layer Formation Step>

In a coating layer formation step (FIG. 8(d)), coating layer 20 containing nickel or a nickel alloy is formed on the surface of core wire 10 having been subjected to the electroless plating. Coating layer 20 can be formed by carrying out plating. The plating may be electroless plating or electroplating. The present step is a step similar to a conventional coating layer formation step (FIG. 7(e)).

In the case of the electroless plating, as a plating solution, a well-known one, by using which nickel plating can be electrolessly carried out, can be used.

In the case of the electroplating, a well-known nickel plating solution can be used. Examples of the nickel plating solution to be used for the electroplating include Watts baths containing nickel sulfate, nickel chloride and boric acid as main components, sulfamic acid baths containing nickel sulfamate and boric acid as main components, Wood's baths containing nickel chloride and hydrochloric acid as main components, and black baths containing nickel sulfate, nickel ammonium sulfate, zinc sulfate and sodium thiocyanate as main components. The condition of the electroplating is not especially limited. The current density is, for example, 0.1 A/dm² or more and 20 A/dm² or less. The temperature of the nickel plating solution in the electroplating treatment is, for example, 20° C. or more and 70° C. or less. The treatment time of the electroplating can suitably be set according to a desired thickness.

### <Heat Treatment Step>

Core wire 10 having nickel coating 21 and coating layer 20 formed thereon may be subjected to a heat treatment. By this heat treatment, nickel coating 21 is converted to a metal oxide. That is, by this heat treatment, nickel coating 21 turns to interdiffusion layer 30 containing aluminum, nickel and oxygen. Further, by this heat treatment, the thickness of interdiffusion layer 30 becomes large. This heat treatment does not substantially affect core wire 10 and coating layer 20. Core wire 10 and coating layer 20 in the wire to be obtained after the heat treatment substantially retain the compositions, the thicknesses and the like of core wire 10 and coating layer 20 in the manufacturing process.

The heat treatment temperature is 300° C. or more and 600° C. or less. In the case where the heat treatment temperature is 300° C. or more, nickel coating 21 is well converted to a metal oxide. In the case where the heat treatment temperature is 300° C. or more, the average thickness of interdiffusion layer 30 to be formed is easily made to be 50 nm or more. In the case where the heat treatment temperature is 600° C. or less, the average thickness of interdiffusion layer 30 to be formed is easily made to be 250 nm or less. The heat treatment temperature is preferably 350° C. or more and 550° C. or less and more preferably 400° C. or more and 500° C. or less.

The heat treatment time is 30 s or longer and 60 min or shorter. In the case where the heat treatment time is 30 s or longer, nickel coating 21 is well converted to the metal oxide. In the case where the heat treatment time is 30 s or longer, the average thickness of interdiffusion layer 30 to be formed is easily made to be 50 nm or more. In the case where the heat treatment time is 60 min or shorter, the average thickness of interdiffusion layer 30 to be formed is easily made to be 250 nm or less. The heat treatment time is preferably 5 min or longer and 30 min or shorter and more preferably 10 min or longer and 15 min or shorter.

Examples of the heat treatment atmosphere include inert gas atmospheres such as an argon atmosphere and a nitrogen atmosphere.

### <Wire Drawing Step>

In a wire drawing step, core wire 10 after the above steps is subjected to wire drawing. By this wire drawing, the wire having a desired wire diameter is fabricated. The wire drawing can be carried out, for example, by a conventionally well-known method such as cold wire drawing or wire drawing using dies.

### Embodiment 4

A method for manufacturing the wire of the present embodiment will be described. Duplicate descriptions with embodiment 3 will be omitted.

### <Etching Step>

In a conventional etching treatment, in the case where the wire contains anchor particles 40, there is posed such a problem that anchor particles 40 themselves are etched by the etching treatment, and anchor particles 40 come off to form voids in core wire 10.

Then, the present inventors, in order to cope with the above problem, have found use for the etching treatment of an etching solution to which solution the solubility of aluminum oxide being a main component of oxide film 11 is higher than the solubility of the oxide of the first element being the outer layer of anchor particle 40. Thereby, excessive etching of anchor particles 40 is suppressed and coming-off of anchor particles 40 is also suppressed.

Such an etching solution includes aqueous solutions containing sulfamic acid or a sulfamate salt, as described in above-mentioned embodiment 3. The etching solution meets the above-mentioned relation of the solubility. That is, it is met that the solubility of aluminum oxide to the etching solution is higher than that of the oxide of the first element thereto.

The solubility of each component of aluminum oxide and the oxide of the first element to the etching solution is determined as follows. That is, the solubility is determined by calculating the amount of each component dissolved when 1 g of each component is immersed for 120 min in 100 g of the etching solution (concentration: 10% by mass) at 25° C.

### EXAMPLES

The present embodiments will be described more specifically by way of Examples. However, the present embodiments are not any more limited to these Examples.

### Sample 1

### (Preparation Step)

As a core wire of a wire, an aluminum alloy of 1.0 mm in diameter was used. The aluminum alloy corresponded to JIS A5052.

### (Degreasing Step)

The prepared core wire was immersed for 90 s in a sodium hydroxide aqueous solution (40 g/L) at 70° C. to be degreased.

### (Etching Step)

The degreased core wire was immersed for 5 min in a sulfamic acid aqueous solution (5% by mass) at 70° C. to be etched. By the etching, an oxide film was completely removed. Here, the oxide film was constituted of aluminum oxide.

### (Electroless Plating Step)

The core wire after the etching was immersed for 2 min in a nickel plating solution at 60° C. to be subjected to electroless plating. The nickel plating solution contained nickel sulfate hexahydrate (26 g/L) and glycine (23 g/L), and had a pH at 25° C. made to be 9.5. Thereby, a nickel coating was formed on the surface of the core wire.

### (Coating Layer Formation Step)

The core wire having the nickel coating formed thereon by the electroless plating was immersed in a Watts bath at 55° C. and subjected to electroplating. The current density of the electroplating was made to be 6.0 A/dm². The electroplating was carried out until a coating layer having a desired thickness was formed on the surface of the nickel coating. The average thickness of the coating layer was made to be 10 μm.

### (Heat Treatment Step)

The core wire having the coating layer formed thereon by the electroplating was subjected to a heat treatment. The heat treatment temperature was made to be 400° C.; the heat treatment time, to be 10 min; and the heat treatment atmosphere, to be the air atmosphere. Thereby, the nickel coating turned to an interdiffusion layer.

### (Wire Drawing Step)

The core wire after the heat treatment was subjected to cold wire drawing to thereby obtain a wire of Sample 1. The diameter of the wire was made to be 0.2 mm.

### Sample 2

Sample 2 was fabricated by the same method as in the above-mentioned Sample 1, except for carrying out no heat treatment.

### Sample A

Sample A was fabricated by the same method as in the above-mentioned Sample 1, except for carrying out etching by immersing the core wire for 150 s in a sodium hydroxide aqueous solution (50 g/L) at 70° C. in the etching step.

### Sample B

Sample B was fabricated by the same method as in the above-mentioned Sample 1, except for carrying out etching by the same method as in the above-mentioned Sample A and carrying out no heat treatment.

### Sample 3

Sample 3 was fabricated by the same method as in the above-mentioned Sample 1, except for using an aluminum-iron alloy of 1.0 mm in diameter as the core wire of a wire. The average thickness of the coating layer was made to be 10 μm.

### Sample 4

Sample 4 was fabricated by the same method as in the above-mentioned Sample 1, except for using the same aluminum-iron alloy as in the above-mentioned Sample 3 as the core wire of a wire, and carrying out no heat treatment.

### Sample C

Sample C was fabricated by the same method as in the above-mentioned Sample 1, except for using the same aluminum-iron alloy as in the above-mentioned Sample 3 as the core wire of a wire, and carrying out etching by the same method as in the above-mentioned Sample A.

### Sample D

Sample D was fabricated by the same method as in the above-mentioned Sample 1, except for using the same aluminum-iron alloy as in the above-mentioned Sample 3 as the core wire of a wire, carrying out etching by the same method as in the above-mentioned Sample A, and carrying out no heat treatment.

### <Observation of Samples>

### (Interdiffusion Layer)

For each Sample obtained, the cross-section was observed by SEM (manufactured by Carl Zeiss AG, Ultra55), and a composition analysis was carried out by using an energy dispersive X-ray spectrometer (EDX) (manufactured by Thermo ELECTRON Corp., trade name: NSS300). As a result, in Samples 1, 3, A and C, which had been subjected to the heat treatment, an interdiffusion layer was provided. It was confirmed that any Sample having an interdiffusion layer formed therein had a base layer having a relatively high content of aluminum on the core wire side and a composite layer having a relatively high content of nickel on the coating layer side. Here, the base layer and the composite layer contained oxygen, in addition to aluminum and nickel.

The average thickness of the interdiffusion layer was determined by observing the cross-section by SEM, and measuring the thicknesses of 10 different positions of the interdiffusion layer and using the average value thereof. The average thicknesses of the interdiffusion layers are shown in the “Interdiffusion layer Thickness (μm)” column of Table 1.

### (Anchor Particle)

For each Sample obtained, the cross-section was observed by SEM, and the composition analysis was carried out by using EDX. As a result, it was confirmed that in Samples 1, 2, A and B, there were anchor particles constituted of an outer layer consisting of magnesium oxide and an inner layer consisting of magnesium; and in Samples 3, 4, C and D, there were anchor particles constituted of an outer layer consisting of iron oxide and an inner layer consisting of iron. Further, it was confirmed that in any Sample thereof, the anchor particles were present straddling the interface between the core wire and the coating layer.

The particle diameter of the anchor particle was determined by observing the cross-section by SEM, and measuring the major axis lengths of 10 different anchor particles and using the average value thereof. The particle diameters of the anchor particles are shown in the “Anchor Particle Particle diameter (μm)” column of Table 1.

The area ratio of the anchor particles was obtained by mirror finishing a cut face obtained by cutting each Sample, observing the mirror finished face by SEM to obtain photographed images of 10 different visual fields, and carrying out binarization processing with the threshold value of lightness being taken to be 120 by using an image processing software (“ImageJ”) to thereby obtain a binarized image. Based on the binarized image, the area ratio of the anchor particles in the mirror finished face of each Sample was determined. The calculated area ratio of the anchor particles is shown in the “Anchor particle Area ratio (%)” column of Table 1. Here, one visual field was made to be 1.5 μm long×2.2 μm wide, and the mirror finishing was carried out on the portion within 10 μm of the surface.

### (Area Ratio)

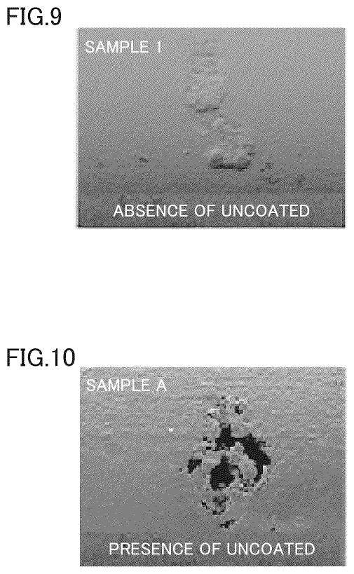

On the core wire, the area ratio of portions not being coated with the coating layer was determined by, for each Sample obtained, mirror finishing the surface of the coating layer, observing the mirror finished face by SEM and image analyzing photographed images of 10 different visual fields, and using the average value thereof. The area ratio is shown in the “Area ratio (%)” column of Table 1. The area ratio of portions not being coated with the coating layer was a value obtained by calculating an area of the portions not being coated with the coating layer from the photographed images, and dividing an area of the visual fields of the photographed images by the area of the portions not being coated with the coating layer in the photographed images. Here, one visual field was made to be 350 μm long×500 μm wide. Then, in FIGS. 9 and 10, SEM images of surfaces of the coating layers of Sample 1 and Sample A are shown. Then, in the case where the Sample had the interdiffusion layer, the above-mentioned area ratio means an area ratio of portions not being coated with the coating layer and the interdiffusion layer.

### <Adhesiveness Evaluation>

The adhesiveness evaluation involved carrying out self-diameter bending of the wire of each Sample on a rod having the same wire diameter as that of the wire. The state of the coating layer was evaluated by observing, by SEM, the presence/absence of cracks in and peeling of the coating layer in the wire of each Sample having been subjected to the self-diameter bending. In the evaluation of the state of the coating layer, the case where no cracks in and no peeling of the coating layer occurred was taken as “A”; the case where a few cracks in the coating layer occurred was taken as “B”; and the case where many cracks in the coating layer occurred was taken as “C”. Here, a few cracks referred to the case where even when the surface of the coating layer was enlarged to a magnification of 200 times by SEM, the exposure of aluminum could not be distinguished visually, and when the surface of the coating layer was enlarged and observed in a magnification of 2,000 times by SEM, and analyzed by EDX, aluminum was detected. Many cracks referred to the case where when the surface of the coating layer was enlarged to a magnification of 200 times, the exposure of aluminum could be distinguished visually. The results are shown in the “Adhesiveness” column of Table 1.

### <Solubility>

The solubilities were calculated by immersing 1 g of each component of aluminum oxide, aluminum, magnesium oxide and iron oxide for 120 min in 100 g of the sulfamic acid aqueous solution (10% by mass) at 25° C. used in the above, and calculating the amount dissolved in the immersion. As a result, the solubilities of aluminum oxide, aluminum, magnesium oxide and iron oxide were 0.05131 g, 0.00031 g, 0.03235 g and 0.00032 g, respectively. From this result, with regard to the solubility of the above each component to the etching solution used in the present Examples, it was found that the solubility of aluminum oxide was higher than that of aluminum; and the solubility of aluminum oxide was higher than that of magnesium oxide and iron oxide. Then, when the solubilities of magnesium and iron were calculated in the same manner, the solubilities were 0.94177 g and 0.00121 g, respectively. Since the solubility of magnesium was remarkably high, it is preferable that after the aluminum oxide being a main component of the oxide film is fully removed, the etching treatment is finished before the magnesium oxide being an outer layer of the anchor particle is removed.

TABLE 1

| | | | | | | | | Coating | |
|---|---|---|---|---|---|---|---|---|---|
| | | | | | Anchor particle | | | layer | |
| | Treatment method | | Interdiffusion layer | | | Particle | Area | Area | |
| | Etching | Heat | Presence/ | Thickness | | diameter | ratio | ratio | Evaluation |
| Sample | treatment | treatment | absence | (μm) | Component | (μm) | (%) | (%) | Adhesiveness |
| 1 | sulfamic | present | present | 0.21 | magnesium | 1.0 | 3 | 0 | A |
| 2 | acid | none | none | — | oxide | 1.0 | 3 | 0 | C |
| 3 | | present | present | 0.2 | iron oxide | 0.2 | 2 | 0 | A |
| 4 | | none | none | — | | 0.2 | 2 | 0 | C |
| A | sodium | present | present | 0.2 | magnesium | 1.0 | 3 | 0.01 | B |
| B | hydroxide | none | none | — | oxide | 1.0 | 3 | 0.01 | C |
| C | | present | present | 0.21 | iron oxide | 0.2 | 2 | 0.02 | C |
| D | | none | none | — | | 0.2 | 2 | 0.02 | C |

As indicated in Table 1, the wires of Samples 1 to 4 had an area ratio of portions not being coated with the coating layer of 0%, that is, exhibited no exposure of the core wire. As shown in FIG. 9, it was confirmed from the SEM photograph that Sample 1 exhibited no exposure of the core wire. By contrast, the wires of Samples A to D had, on the core wires, area ratios of portions not being coated with the coating layers of 0.01%, 0.01%, 0.02% and 0.02%, respectively. Then, as shown in FIG. 10, it was confirmed from the SEM photograph that Sample A exhibited exposure of the core wire.

The wires of Samples 1 and 3, even when bending acted thereon, caused no cracks in and peeling of the coating layers; and in the coating layer of Sample A, a few cracks occurred. By contrast, in the coating layers of Samples 2 and 4 and B to D, many cracks occurred.

Embodiments and Examples of the present disclosure have been described as in the above, but it is envisaged from the beginning that constitutions of the above-mentioned embodiments and Examples may suitably be combined or variously modified.

It is to be understood that the embodiments disclosed herein are illustrative and not restrictive. The scope of the present invention is defined not by the above-mentioned embodiments but by the claims, and is intended to cover all modifications within the meaning and range equivalent to the claims.

### REFERENCE SIGNS LIST

10 CORE WIRE; 11 OXIDE FILM; 20 COATING LAYER; 21 NICKEL COATING; 30 INTERDIFFUSION LAYER; 31 BASE LAYER; 32 COMPOSITE LAYER; 33 BASE PART; 34 COATING PART; 35 RECESSED PART; 40 ANCHOR PARTICLE

What is claimed:

1. A wire, comprising:
a core wire; and
a coating layer positioned on an outer periphery of the core wire,
wherein the core wire consists essentially of aluminum or an aluminum alloy;
the coating layer consists essentially of nickel or a nickel alloy;
on the core wire, an area ratio of portions not being coated with the coating layer is lower than 0.01%;
the wire further comprises a first element; and
the first element is at least one selected from the group consisting of iron, magnesium, silicon, copper, zinc, nickel, manganese, silver, chromium and zirconium.

2. The wire according to claim 1,
wherein the wire further comprises an anchor particle comprising the first element and an oxide of the first element; and
the anchor particle is present straddling an interface between the core wire and the coating layer.

3. The wire according to claim 2, wherein the anchor particle has a particle diameter of 0.1 μm or more and 50 μm or less.

4. The wire according to claim 1, further comprising an interdiffusion layer between the core wire and the coating layer,
wherein the interdiffusion layer comprises aluminum, nickel and oxygen.

5. The wire according to claim 4,
wherein the interdiffusion layer comprises a base layer positioned on the core wire side and a composite layer positioned on the coating layer side;
the base layer has a higher content of aluminum than a content of nickel; and
the composite layer has a higher content of nickel than a content of aluminum.

6. The wire according to claim 4, wherein the interdiffusion layer has an average thickness of 10 nm or more and 250 nm or less.

7. The wire according to claim 4, wherein the interdiffusion layer has an average thickness of 50 nm or more and 250 nm or less.

8. The wire according to claim 1, wherein the coating layer has an average thickness of 3 μm or more and 15 μm or less.

9. The wire according to claim 1, wherein the wire has a diameter of 0.04 mm or more and 4 mm or less.

10. A method for manufacturing a wire comprising a core wire and a coating layer positioned on an outer periphery of the core wire, the method comprising:
preparing the core wire consisting essentially of aluminum or an aluminum alloy;
carrying out degreasing to remove oil content adhered on a surface of the core wire;
carrying out an etching treatment to remove an oxide film present on a surface of the core wire and containing aluminum oxide as a main component;
carrying out electroless plating to form a nickel coating on a surface of the core wire having been subjected to the etching treatment;
forming the coating layer consisting essentially of nickel or a nickel alloy on a surface of the core wire having the nickel coating formed thereon; and
subjecting the core wire having the coating layer formed thereon to wire drawing,
wherein the wire further comprises a first element;
the first element is at least one selected from the group consisting of iron, magnesium, silicon, copper, zinc, nickel, manganese, silver, chromium and zirconium; and
a solubility of aluminum oxide to an etching solution to be used for the etching treatment is higher than a solubility of aluminum to the etching solution.

11. The method for manufacturing a wire according to claim 10,
wherein the wire further comprises an anchor particle comprising the first element and an oxide of the first element; and
the anchor particle is present straddling an interface between the core wire and the coating layer.

12. The method for manufacturing a wire according to claim 10, wherein an etching time in the etching treatment is 1 min or longer and 5 min or shorter.

13. The method for manufacturing a wire according to claim 10, wherein the etching solution comprises sulfamic acid or a sulfamate salt.

14. The method for manufacturing a wire according to claim 10, further comprising subjecting the core wire having the coating layer formed thereon to a heat treatment at a temperature of 300° C. or more and 600° C. or less to form an interdiffusion layer comprising aluminum, nickel and oxygen between the core wire and the coating layer.
